(19) United States
(12) Patent Application Publication
(10) Pub. No.: US 2010/0176779 A1
(43) Pub. Date: Jul. 15, 2010

(54) Power supply device and electronic apparatus

(75) Inventors: Yoshito Koyama, Kawasaki (JP); Minoru Hirahara, Kawasaki (JP); Seiji Miyoshi, Kawasaki (JP); Eiji Miyachika, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/659,727

(22) Filed: Mar. 18, 2010

Related U.S. Application Data
(63) Continuation of application No. PCT/JP2007/068193, filed on Sep. 19, 2007.

(51) Int. Cl. G05F 1/10

(52) U.S. Cl. 323/282

(57) ABSTRACT

A power supply device includes: a power supply plane to which a processing circuit is electrically connected to supply electrical power to the processing circuit and in which the processing circuits are connected to each supply place; plural OBP's each of which applies a voltage to the power supply plane to supply electrical power to the processing circuits via the power supply plane; and a power supply control section which controls an application voltage in individual one of the OBP's by reflecting a status of power supplying in other OBP's other than the individual one out of the plural OBP's to uniform a dispersion of voltages between the supply places.

### CROSS-REFERENCE TO RELATED APPLICATION

This is a continuation application of PCT/JP2007/068193, filed on Sep. 19, 2007.

### TECHNICAL FIELD

The embodiment discussed herein is related to a power supply device that supplies power to a processing device and an electronic apparatus mounted with the power supply device.

### BACKGROUND ART

Conventionally, in an electronic apparatus such as a communication device and a server device, there is provided a power supply device that supplies power to an IC or the like that executes various kinds of processing. Such power supply device is required of supplying stable power consistently, and in particular, required of adjusting an output voltage that is outputted to an IC or the like to be constant.

FIG. 1 schematically illustrates a structure of a power supply device that supplies power to an electronic apparatus.

A power supply device 10 illustrated in FIG. 1 is a power supply device employing an analog control method in which an output voltage to an IC or the like is controlled with the use of an analog component such as an amplifier and a comparator.

The power supply device 10 includes a voltage detection circuit 11, an error amplifier 12, a compensation circuit 13, a reference oscillator 14, a comparator 15, a switch element 16, a smoothing filter 17 and so on.

Firstly, in the voltage detection circuit 11, a power output voltage Vout that is currently outputted from the power supply device 10 to an IC or the like is detected, and the detected output voltage Vout is transmitted to the error amplifier 12. In the error amplifier 12, a difference between the output voltage Vout and a reference voltage V0 is amplified and outputted. In the compensation circuit 13, an amplified voltage Vg that is outputted from the error amplifier 12 is adjusted to a value appropriate to the sensitivity of the comparator 15.

In the reference oscillator 14, a voltage signal Vp of sawtooth waveform is outputted at a given frequency. In the comparator 15, the voltage signal Vp of sawtooth waveform outputted from the reference oscillator 14 is compared with the amplified voltage Vg that has been adjusted in the compensation circuit 13, and a control signal that becomes “ON” while the voltage signal Vp of sawtooth waveform is smaller than the amplified voltage Vg, and becomes “OFF” at all other times is transmitted to the switch element 16.

In the switch element 16, since “ON-OFF” is thus controlled by the control signal transmitted from the comparator 15, a pulse width of the input voltage Vin that has been inputted to the power supply device 10 is adjusted, and a smoothing operation is executed in the smoothing filter 17. As a consequence, the output voltage Vout whose voltage value has been adjusted is outputted from the power supply device 10 to an electronic apparatus. For example, if the output voltage Vout detected in the voltage detection circuit 11 drops, an error between the output voltage Vout and the reference voltage V0 which is calculated in the error amplifier 12 becomes large. As a consequence, the voltage signal Vp of sawtooth waveform becomes smaller than the amplified voltage Vg, causing “ON” duration of the control signal outputted from the comparator 15 longer, so that the pulse width of the input voltage Vin is adjusted to be longer and the output voltage Vout is raised.

In the power supply device 10, the output voltage that is outputted to a processing section is controlled to be constant as described above.

Here, in an electronic apparatus, various kinds of components, an IC and the like which are included in the electronic apparatus are supplied with power to operate. A power consumption in each of these components, the IC and the like changes in accordance with an amount of load in processing shared by each of the components, the IC and the like. If such individual fluctuation of load is moderate, it is possible to supply required power consistently by absorbing the fluctuation of load in each component and thus maintaining a voltage to be applied to the components, the IC and the like to be constant. However, in a communication device or a server device among the electronic apparatuses, there is a case in which a load in the IC or the like that executes communication processing abruptly fluctuates in synchronization with a state of communications traffic, which makes it difficult to absorb abrupt fluctuations of load in such a local place under an overall control by a single power supply device.

For this reason, there is proposed a technique that absorbs local fluctuations of load individually and maintains necessary power supply independently by providing plural power supply devices in such a manner that at least one power supply device is disposed near various kinds of components, an IC and the like included in an electronic apparatus, and by individually controlling a voltage to be applied to the various kinds of components, the IC and the like (see U.S. Pat. No. 6,646,425, for example).

However, even if the voltage to be applied to the various kinds of components, the IC and the like is controlled individually by the technique disclosed in the U.S. Pat. No. 6,646,425, in a case where fluctuations of load in a component that adjoins a component targeted for controlling by a power supply device are too large, there often occurs a problem that the power supply device may not be able to maintain proper power supply to the control target, by being affected by the fluctuations of load in other component that is not targeted for controlling.

### DISCLOSURE OF INVENTION

According to an aspect of the invention, a power supply device includes:

a power supply plane to which a processing device is electrically connected to supply electrical power to the processing device, and in which plural processing devices are connected to each supply place;

plural power supplies each of which applies a voltage to the power supply plane to supply electrical power to the processing devices via the power supply plane; and

a power supply control section which controls an application voltage in individual one of the plural power supplies by reflecting a status of power supplying in other power supplies other than the individual one out of the plural power supplies to uniform a dispersion of voltages between the supply places.

According to the power supply device of the aspect of the present invention, even in a case where a large fluctuation of load occurs in a part of the processing devices among the above-described plural processing devices, which may affect on the power control to the other processing devices through the above-described power supply plane, different voltages in the above-described supply places on the power supply plane are uniformed and thus the fluctuations of load are effectively controlled so as not to affect the power control of the other processing devices. By this, it is possible to avoid a problem that that each power supply may not be able to maintain proper power supply to its power supply target, by being affected by the fluctuations of load in the component that is not targeted for controlling. That is, according to the power supply device of the present invention, it is possible to supply power well to various kinds of components and an IC or the like included in an electronic apparatus (processing device), respectively.

In the power supply device of the present invention, it is a preferable mode that a status recognition section is further included, which recognizes the status of power supplying in individual one of the power supplies, wherein the power supply control section uses the status of power supplying recognized in the individual one of the power supplies by the status recognition section and controls each application voltage by reflecting the status of power supplying in other power supplies other than the individual one out of the plurality of power supplies.

According to the power supply device of this preferable mode, it is possible to control each application voltage easily by reflecting the status of power supplying in other power supplies.

According to another aspect of the invention, an electronic apparatus includes:

plural processing devices each of which executes processing by receiving voltage application; and

a power supply device that includes:
a power supply plane to which a processing device is electrically connected to supply electrical power to the processing device, and in which the processing devices are connected to each supply place;
power supplies each of which applies a voltage to the power supply plane to supply electrical power to the processing devices via the power supply plane; and
a power supply control section which controls an application voltage in individual one of the power supplies by reflecting a status of power supplying in other power supplies other than the individual one out of the power supplies to uniform a dispersion of voltages between the supply places.

According to the electronic apparatus of another aspect of the present invention, it is possible to well supply power respectively to various kinds of components and an IC or the like included in the electronic apparatus. Incidentally, only a basic mode is illustrated for the electronic apparatus of the present invention. However, this is for the intention of avoiding redundancy, and the electronic apparatus of the present invention may include not only the basic mode but also various kinds of modes corresponding to the previously described each mode of the power supply device.

According to the present invention, it is possible to obtain a power supply device capable of well supplying power respectively to various kinds of components and an IC or the like included in an electronic apparatus and an electronic apparatus mounted with the power supply device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a power supply device that supplies power to an electronic apparatus;

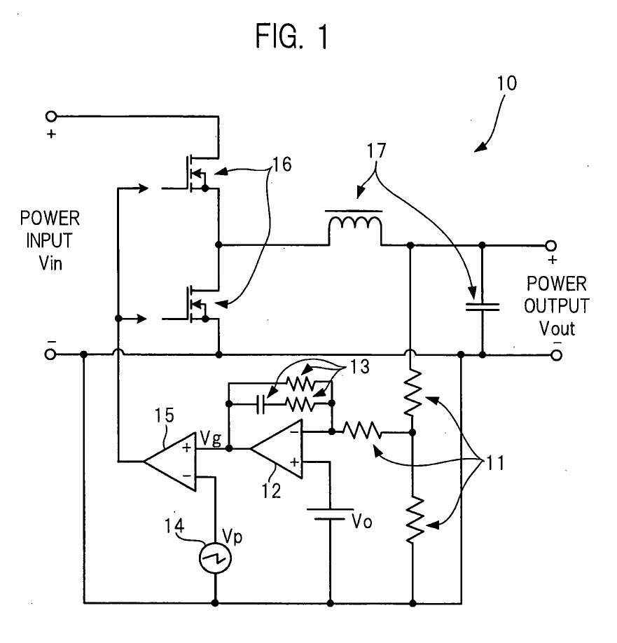

FIG. 2 is an external perspective view of a communication unit according to one embodiment of the present invention;

FIG. 3 is a perspective view of a holding plate 210 included in an electronic circuit package 200;

FIG. 4 is a schematic diagram of the electronic circuit package 200 in which a board 220 is attached to the holding plate 210;

FIG. 5 is a schematic functional block diagram of the plural electronic circuit packages 200 illustrated in FIG. 2;

FIG. 6 is a diagram to explain a flow of power supply in the electronic circuit package 200;

FIG. 7 is a schematic diagram of a processing circuit 221, an OBP 223 that supplies power to the processing circuit 221, and a power supply control section 224 also illustrated in FIG. 5;

FIG. 8 is a schematic functional block diagram of three electronic circuit packages among plural electronic circuit packages to be mounted in a communication device; and

FIG. 9 is a diagram to explain a flow of power supply in a signal processing package 400_3.

### BEST MODE FOR CARRYING OUT THE INVENTION

Embodiments of the present invention will be described with reference to the drawings.

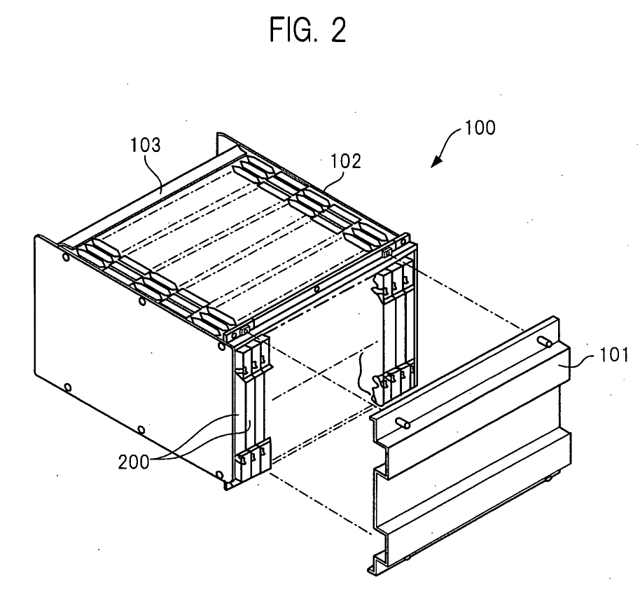

FIG. 2 is an external perspective view of a communication unit according to one embodiment of the present invention.

A communication unit 100 is one example of the electronic apparatus according to the present invention, which transmits and receives data via a network. The communication unit 100 includes a unit cover 101, a unit frame 102, a back panel 103, and plural electronic circuit packages 200 housed in a space enclosed with these cover, frame and back panel to execute processing.

On an inside of the back panel 103, various kinds of connectors (not illustrated) to transmit data and power are provided. These connectors are engaged with connectors arranged in the plural electronic circuit packages 200, respectively so that the plural electronic circuit packages 200 are connected to each other.

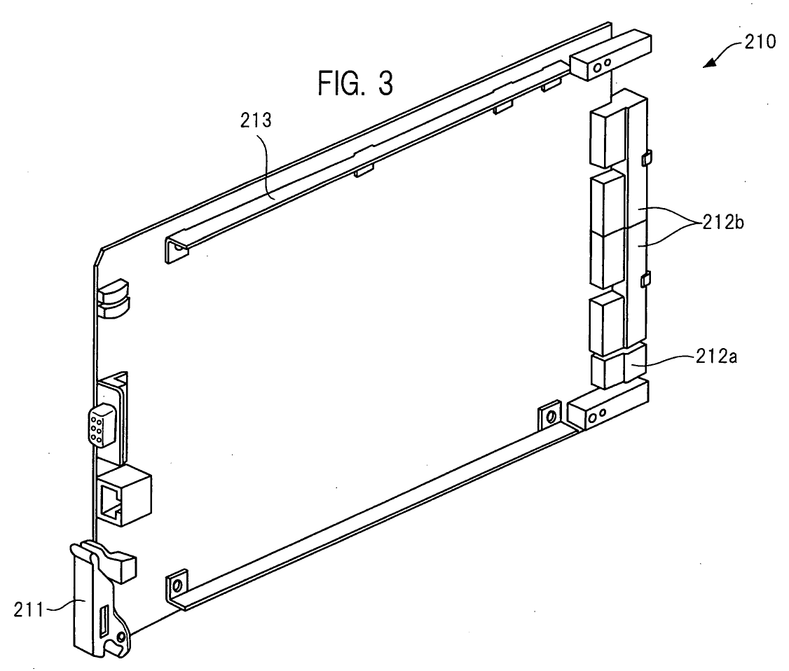

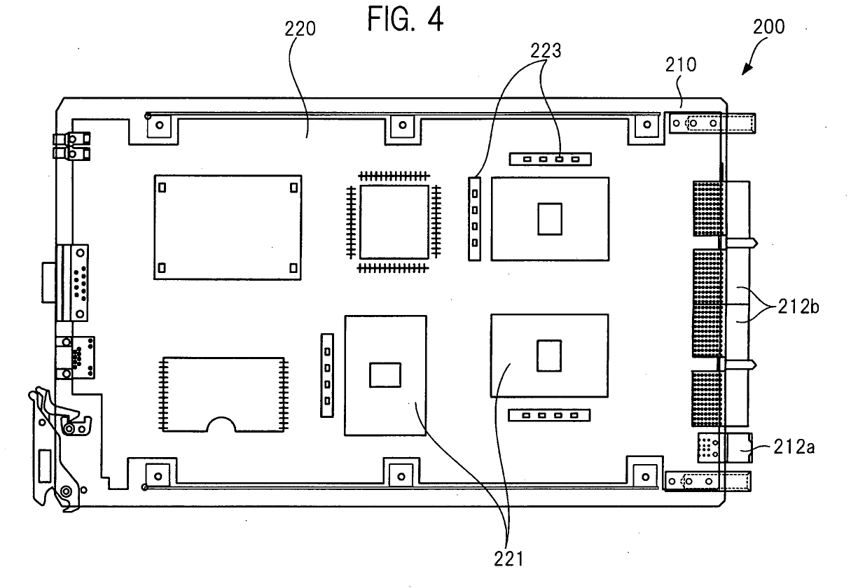

The plural electronic circuit packages 200 sequentially execute processing for communication data transmitted via a network, and in response to processing executed by an upstream electronic circuit package 200, execution of processing by a downstream electronic circuit package 200 starts. Additionally, each electronic circuit package 200 includes a board 220 (see FIG. 4) to which an IC or the like is mounted and a holding plate 210 (see FIG. 3) for holding the board 220.

FIG. 3 is a perspective view of the holding plate 210 included in the electronic circuit package 200, and FIG. 4 is a schematic diagram of the electronic circuit package 200 in which the board 220 is attached to the holding plate 210.

The holding plate 210 includes a grip section 211 to be gripped with a hand when inserting and extracting the holding plate 210 to and from the unit frame 102 in FIG. 2, a power connector 212a to input power to the electronic circuit package 200, a curve preventing metal member 213 to prevent curving of the board 220, and data connectors 212b to transmit and receive various kinds of data and the like.

FIG. 4 illustrates the electronic circuit package 200 in a state in which the board 220 is attached to the holding plate 210. The board 220 is equipped with plural processing circuits 221 such as an IC, and OBP's 223 to supply power to each of the plural processing circuits 221. The board 220 is fitted into the holding plate 210, the power connector 212a and the data connectors 212b in the holding plate 210 are inserted into the board 220, and thus the board 220 is attached to the holding plate 210. Furthermore, the holding plate 210 is fitted into the unit frame 102 illustrated in FIG. 2 to be connected to a connector in the back panel 103, and thus the plural electronic circuit packages 200 are connected to each other.

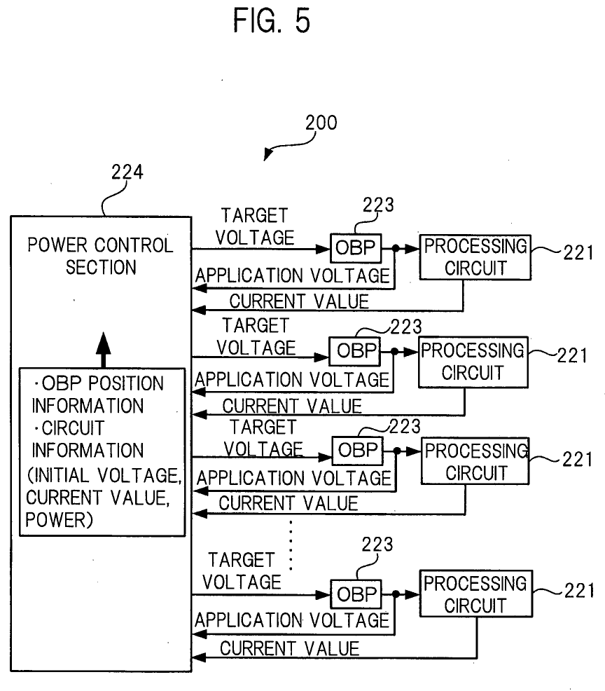

FIG. 5 is a schematic functional block diagram of the plural electronic circuit packages 200 illustrated in FIG. 2.

The electronic circuit package 200 includes a power supply control section 224 that detects an application voltage to be applied to the processing circuit 221 by each of the OBP's 223 in a manner to be described later, and controls power supply in the respective OBP's 223 such that a difference is compensated between the detected application voltage and a target voltage.

Here, in this embodiment, since the plural processing circuits 221 are planned to have an equal operation voltage in the design, a common power supply plane to which all the processing circuits are to be connected electrically is provided on the board 220 of the electronic circuit package 200. Each OBP 223 applies a voltage to this common power supply plane to supply power via the power supply plane to a processing circuit 221 that is disposed most closely to each OBP 223 on the board 220 as a main power supply target. Hereafter, this main power supply target is simply referred to as a power supply target.

In the power supply control section 224, a value of a current flowing into each of the processing circuits 221 detected by a predetermined current detection circuit is inputted. From these inputted current values, power consumption in each of the processing circuits 221 is calculated, and a result of the calculation is saved in a memory 224_1 in the power supply control section 224 as a piece of circuit information indicating a processing load of the processing circuit 221, together with the detected current values in each of the processing circuits 221. The detection of the current values for each of the processing circuits 221 and the calculation of power consumption in each of the processing circuits 221 are repeated in a predetermined time interval and the piece of circuit information in the memory 224_1 is updated each time they are repeated.

Incidentally, in the memory 224_1 in the power supply control section 224, a piece of position information indicating a position of each of the OBP's 223 on the board 220 is also saved, including a relative position relation with respect to each of the OBP's 223 as well. Here, the processing load in each of the processing circuits 221 indicated by the piece of circuit information is an example of “a status of power supplying in the plural power supplies” according to the present invention.

In the power supply control section 224, a target voltage in each of the OBP's 223 is calculated each time of update, based on the piece of position information and the piece of circuit information that are repeatedly updated. Here, in the present embodiment, when a target voltage is calculated for each of the OBP's 223, not only the piece of circuit information in one processing circuit 221 that is a power supply target of a certain OBP 223, but also the piece of circuit information in another processing circuit 221 that is a power supply target of other OBP's 223 is reflected.

In the power supply control section 224, the above-described power control to each of the OBP's 223 is executed by using the target voltage that changes incessantly in accordance with a processing status in each of the processing circuits 221. The power supply control section 224 is an example of a combination of the power supply control section and the status recognition section according to the present invention. The OBP 223 is an example of the power supply according to the present invention, and the processing circuit 221 is an example of the processing device according to the present invention.

In the memory 224_1 of the power supply control section 224, a value of operation voltage that is planned commonly for the plural processing circuits 221 in the design is saved as a target voltage (initial voltage) immediately after the power-on of the electronic circuit package 200, and this initial voltage is used in controlling power in each of the OBP's 223 immediately after the power-on.

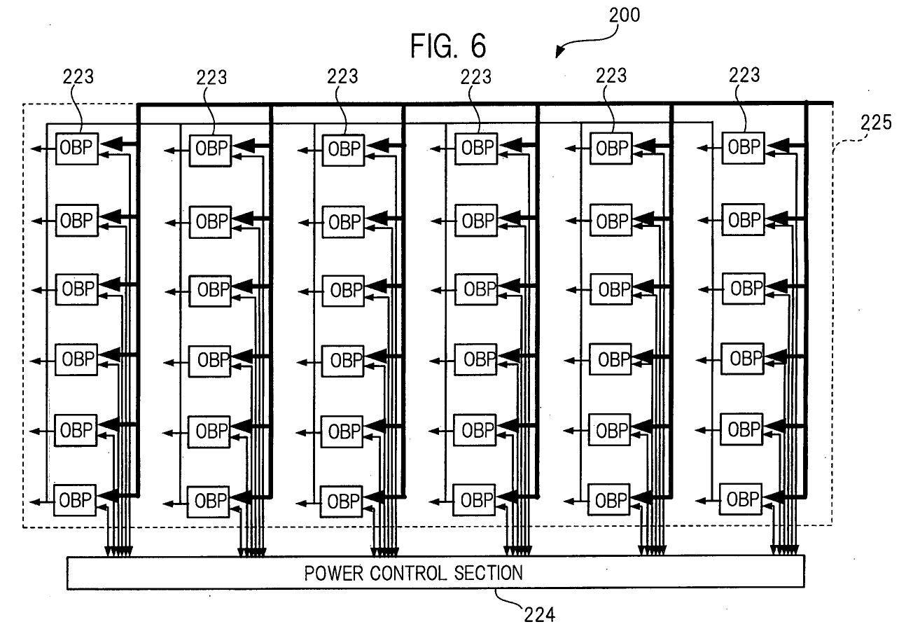

FIG. 6 is a diagram to explain a flow of power supply in the electronic circuit package 200. Incidentally, in FIG. 6, the plural processing circuits 221 illustrated in FIG. 5 are not illustrated for easier understanding.

Each of the plural OBP's 223 generates power to be supplied to each of the processing circuits 221 based on power to be inputted from outside the electronic circuit package 200 via the power connector 212a illustrated in FIG. 4. On the board 220 in FIG. 4, there is provided a power supply plane 225 to which each of the processing circuits 221 is electrically connected and thereby receives power supply. In FIG. 6, the power supply plane 225 is schematically illustrated. Each OBP 223 applies a voltage to the power supply plane 225 and thereby supplies power via the power supply plane 225 to one processing circuit 221 that is disposed closely to one OBP 223 on the board.

The power supply control section 224 detects the application voltage applied to the processing circuit 221 by each of the OBP's 223, and controls power supply in each of the OBP's 223 such that a difference is compensated between the detected application voltage and the target voltage that may incessantly fluctuate in response to a processing status in each of the processing circuit 221.

Here, assuming that the target voltage in all the OBP's 223 is fixed to a planned operation voltage from the design that is used as an initial voltage in the present embodiment. At this time, if a sum of processing loads in some processing circuits 221 that adjoin one another significantly increases and so a current is concentrated in these some processing circuits 221, in the plural OBP's 223 having these some processing circuits 221 as the power supply targets, a situation may arise in which the processing loads may not borne by the power control having the operation voltage as the target, and eventually each of the OBP's 223 fails to maintain the application voltage to the operation voltage.

Therefore, in the present embodiment, the target voltage is variable, and the target voltage of one OBP's 223 is calculated according to a sum of the processing loads in adjacent processing circuits 221 in an area including not only the processing load in the processing circuit 221 that is a power supply target of the one OBP 223, but also the processing load in another processing circuit 221 that adjoins the processing circuit 221 as the power supply target.

Hereafter, calculation of the target voltage in the power supply control section 224 will be explained.

In the present embodiment, calculation of the target voltage for each of the OBP's 223 is executed by feedback processing as described in the following.

When calculating the target voltage for one OBP 223, firstly, a piece of circuit information for the processing circuit 221 that is a power supply target of the one OBP 223 and a piece of circuit information for other processing circuit 221 that adjoins the one processing circuit 221, which are saved in the memory 224_1 are read. Here, a processing load indicated by the piece of circuit information for the other adjoining processing circuit 221 is an example of “the status of power supplying in other power supplies” according to the present invention. A sum of the processing loads (in the present embodiment, power consumption in each of the processing circuits 221) indicated respectively by the pieces of circuit information that have been read is calculated, and a target voltage is calculated according to a difference between the sum and an upper limit of load that may be covered when the above-described operation voltage is set as the target voltage.

By this calculation, when a sum of processing loads in some of the processing circuits 221 that adjoin one another significantly increases, the target voltage of each of the OBP's 223 having the processing circuits 221 as a power supply target is calculated so as to become higher than the above-described operation voltage. And each of the OBP's 223 controls power to target the higher target voltage, and thus an application voltage in each of the OBP's 223 is substantially maintained at the operation voltage. As a result, an application voltage in each place of the power supply plane 225 is maintained at the above-described operation voltage and thus the dispersion of the application voltages is smoothed.

Next, a control of the application voltage in OBP 223 will be explained in detail.

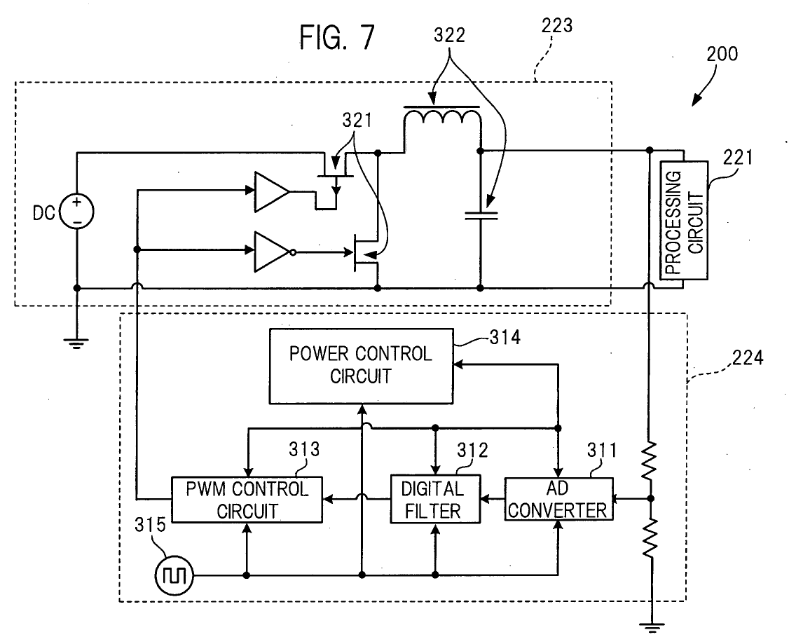

FIG. 7 is a schematic diagram of the processing circuit 221, the OBP 223 that supplies power to the processing circuit 221, and the power supply control section 224 also illustrated in FIG. 5.

Incidentally in FIG. 7, for the sake of simplifying explanation, one processing circuit 221 and one OBP 223 are illustrated.

As illustrated in FIG. 7, the power supply control section 224 includes an AD (Analog-Digital) converter 311, a digital filter 312, a PWM control circuit 313, a power control circuit 314, and a pulse generator 315. The OBP 223 includes a switch element 321, a smoothing filter 322 and the like.

When controlling power supply to the processing circuit 221, basically, in a similar manner as in conventional analog power supply devices, feedback processing is executed, in which power that is supplied later than the present time is controlled based on the power that has been supplied earlier than the present time.

First of all, in the AD converter 311, a voltage that has been applied to the processing circuit 221 from the OBP 223 earlier than the present time is detected, and the detected voltage is converted into digital signal and transmitted to the digital filter 312. The digital filter 312 calculates a difference between the detected voltage and the above-described target voltage, averages the difference and generates an error signal. Here, the calculation of the target voltage is based on the position information and the circuit information as described above. This calculation is made in the power supply control section 314 and the calculated target voltage is transmitted to the digital filter 312.

The error signal generated in the digital filter 312 is transmitted to the PWM control circuit 313.

The PWM control circuit 313 generates a control signal having a pulse width in accordance with a control value transmitted from the power supply control section 314, based on a pulse signal generated from the pulse generator 315 and the error signal transmitted from the digital filter 312, and the generated control signal is transmitted to the switch element 321.

The switch element 321 controls ON-OFF according to the control signal transmitted from the PWM control circuit 313, and as a result, a pulse width of the input voltage is adjusted. Furthermore, a voltage whose pulse width has been adjusted passes through the smoothing filter 322, and thus application voltage is smoothed and power is supplied to the processing circuit 221.

For example, if the application voltage drops, a value of the error signal generated in the digital filter 312 becomes larger and the control signal whose pulse width is longer is generated in the power control circuit 314. As a result, a “ON” duration of the switch element 321 becomes longer, so that the application voltage increases.

Incidentally, as described above, when calculating the target voltage of one OBP 223, not only the processing load in one processing circuit 221 that is a power supply target of the one OBP 223, but also the processing load in other processing circuits 221 that adjoin the one processing circuit 221 is reflected. By this, in the plural OBP's 223 having processing circuits 221 in an area in which the processing load becomes larger as the power supply target, the target voltage becomes larger and a value of the above-described error signal in those OBP's 223 becomes all the more larger, and thus a degree of increase in the application voltage increases, thereby the drop of the application voltage in these OBP's 223 is avoided and thus the dispersion in the application voltages in the power supply plane 225 is smoothed.

As described above, in the present embodiment, by the feedback processing applied to the application voltage and the feedback processing applied to the target voltage, the dispersion in the application voltages in the power supply plane 255 is smoothed and thus power is adequately supplied to each of the processing circuits 221.

Incidentally, calculation of the target voltage is not limited to the above-described feedback processing, but may be executed by feedforward processing as described later. Hereafter, explanation will be made about other mode in which feedforward processing is used along with the feedback processing in calculating the target voltage, based on an assumption that the other mode is applied to a communication unit same as the communication unit 100 that has been explained with reference to FIGS. 2 to 7.

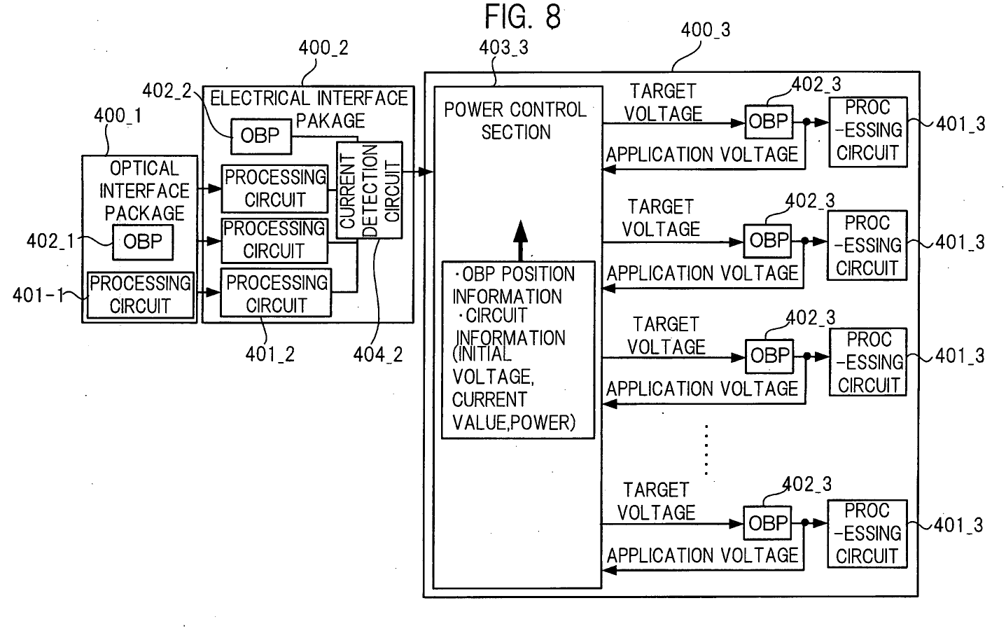

FIG. 8 is a schematic functional block diagram of three electronic circuit packages among the plural electronic circuit packages that are mounted in a communication device.

In the following explanation, various components included in three electronic circuit packages 400_1, 400_2, and 400_3 illustrated in FIG. 8 are identified by their last numbers, respectively.

FIG. 8 illustrates an optical interface package 400_1 that receives optical data transmitted via a network, an electrical interface package 400_2 that converts the optical data received in the optical interface package 400_1 into digital data, and a signal processing package 400_3 that subjects various kinds of signal processing to the digital data converted in the electrical interface package 400_2. In this other mode, power is inputted to the entire communication unit, and after the power is distributed to each OBP 402 in plural electronic circuit packages 400, power is supplied to a processing circuit 401 from the OBP 402 in each of the electronic circuit packages 400.

The electrical interface package 400_2 includes a current detection circuit 404_2 that detects a value of a current flowing into a processing circuit 401_2 when the processing is executed. The signal processing package 400_3 includes a power supply control section 403_3 that obtains the value of the current detected in the current detection circuit 404_2 of the electrical interface package 400_2 and controls power supply in the OBP 402_3 in accordance with the obtained value of the current.

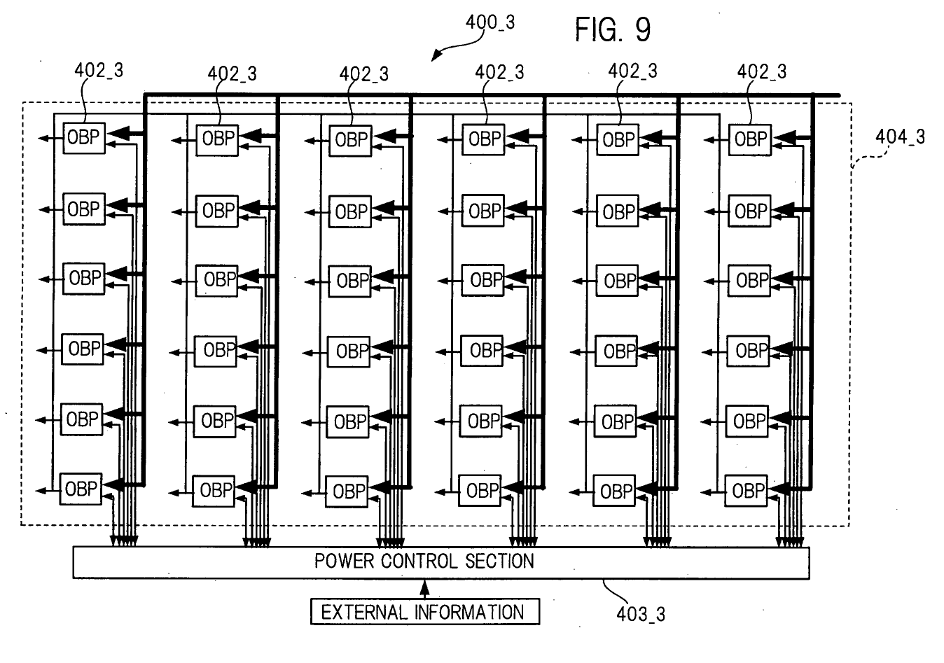

FIG. 9 is a diagram to explain a flow of power supply in the signal processing package 400_3. Incidentally in FIG. 9, the plural processing circuits 401_3 illustrated in FIG. 8 are not illustrated for the sake of easier understanding of the drawing. The power supply control section 403_3 is an example of a combination of the power supply control section and the status recognition section according to the present invention, and the power supply plane 404_3 is an example of the power supply plane according to the present invention.

Here, since the feedback processing in the signal processing package 400_3 is similar to the feedback processing in the electronic circuit package 200 in FIG. 6, redundant explanation is omitted and the explanation will be made with a focus on the feedforward processing.

To the power supply control section 403_3, the value of the current flowing from the upstream electrical interface package 400_2 into the processing circuit 401_2 of the downstream electrical interface package 400_2 is transmitted. In general, the more the amount of communication data targeted for processing increases, the more processing load increases. Generally, among the plural processing circuits 401_3 in the signal processing package 400_3, a large current flows into the processing circuit 401_3 that handles communication processing. Since the value of the current flowing into the upstream electrical interface package 400_2 is transmitted, it is possible to predict a load of processing to be executed from now on in the processing circuit 401_3 that handles communication processing, among the plural processing circuits 401_3. When calculating the target voltage of each OBP 402_3, if this value of the current is larger than a predetermined value, the target voltage is calculated rather extra high for the plural OBP's 402_3 which have the processing circuit 401_3 that handles communication processing and the other processing circuit 401_3 that is adjacent to the processing circuit 401_3, as the power supply targets. As a result, before a processing load of the processing circuit 401_3 that handles communication processing actually increases to generate the dispersion in the application voltage in the power supply plane, each application voltage is controlled so as to maintain a balance in the power supply plane 404_3.

In this way, according to this other mode, power to be supplied later than the present time is adjusted based on the previous processing load in each of the processing circuits 401_3 earlier than present time (feedback control), and also power supply is adjusted according to the processing load in the upstream electrical interface package 400_2 (feedforward control). Also in this other mode described above, similarly to the embodiment in which only the above-described feedback processing is used, the dispersion in the application voltage in the power supply plane 404_3 are smoothed and power is satisfactorily supplied to each of the processing circuits 401_3.

In the above description, as one example of the power supply control section according to the invention, the power supply control sections 224_3 and 402 that calculate the target voltage for each OBP in accordance with a processing load in each processing circuit are described. However, the present invention is not limited to this power supply control section. The power supply control section according to the present invention may have, for example, in a case where a relationship between extents of processing loads is fixed among plural processing devices, a fixed target voltage which has been calculated for each OBP in the design stage by taking the fixed relationship of extents into consideration, and controls supply power with the use of the fixed target voltage of each OBP.

Also in the above-description, as one embodiment of the present invention, the example in which plural OBP's and plural processing circuits are in one-to-one correspondence. However, the present invention is not limited to this one-to-one correspondence, and may be one in which plural power supplies correspond to one processing circuit, or one in which to each plural power supply, plural processing circuits correspond.

Additionally in the above-description, explanation has been made about the example in which power to be supplied to a processing circuit is controlled by adjusting increase and decrease of a voltage to be applied to the processing circuit. However, the power supply control section according to the present invention may be one that controls power to be supplied to the processing circuit by adjusting an amount of a current to be supplied to the processing circuit.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power supply device comprising:
a power supply plane to which a processing device is electrically connected to supply electrical power to the processing device, and in which a plurality of the processing devices are connected to each supply place;
a plurality of power supplies each of which applies a voltage to the power supply plane to supply electrical power to the processing devices via the power supply plane; and
a power supply control section which controls an application voltage in individual one of the plurality of power supplies by reflecting a status of power supplying in other power supplies other than the individual one out of the plurality of power supplies to uniform a dispersion of voltages between the supply places.

2. The power supply device according to claim 1, further comprising a status recognition section that recognizes the status of power supplying in individual one of the power supplies, wherein the power supply control section uses the status of power supplying recognized in the individual one of the power supplies by the status recognition section and controls each application voltage by reflecting the status of power supplying in other power supplies other than the individual one out of the plurality of power supplies.

3. An electronic apparatus comprising:
a plurality of processing devices each of which executes processing by receiving voltage application; and
a power supply device comprising:
a power supply plane to which a processing device is electrically connected to supply electrical power to the processing device, and in which a plurality of the processing devices are connected to each supply place;
a plurality of power supplies each of which applies a voltage to the power supply plane to supply electrical power to the processing devices via the power supply plane; and
a power supply control section which controls an application voltage in individual one of the plurality of power supplies by reflecting a status of power supplying in other power supplies other than the individual one out of the plurality of power supplies to uniform a dispersion of voltages between the supply places.
